(19) United States
(12) Patent Application Publication
(10) Pub. No.: US 2026/0196534 A1
(43) Pub. Date: Jul. 9, 2026

(54) INVERTED CENTRIFUGAL BLOWER SYSTEM AND FUEL CELL INCORPORATING SAME

(71) Applicant: WATT FUEL CELL CORP., Mount Pleasant, PA (US)

(72) Inventors: Caine M. FINNERTY, Mount Pleasant, PA (US); Paul DEWALD, Mount Pleasant, PA (US)

(21) Appl. No.: 19/127,904

(22) PCT Filed: Feb. 3, 2023
(86) PCT No.: PCT/US2023/012282

§ 371 Date: May 7, 2025

(51) Int. Cl. H01M 8/04089; F04D 17/16; F04D 25/16; F04D 29/42; F04D 29/44; F04D 29/70; H01M 8/0438; H01M 8/04746

(52) U.S. Cl. CPC H01M 8/04097; F04D 17/16; F04D 25/166; F04D 29/4206; F04D 29/441; F04D 29/701; H01M 8/04402; H01M 8/0441; H01M 8/04753; H01M 8/04761

(57) ABSTRACT

A centrifugal blower system comprising a series of blower units, each blower unit in the series comprising a casing having an axial inlet and a radial outlet, an impeller disposed within the casing for drawing a gaseous medium at a first pressure into the axial inlet and expelling gaseous medium at a second higher pressure through the radial outlet and a motor for driving the impeller; and, a duct connecting the radial outlet of at least one blower unit in the series of blower units with the axial inlet of at least one other blower unit in the series of blower units, wherein the axial inlet of the at least one blower unit in the series of blower units is positioned substantially opposite to the axial inlet of the at least one other blower unit in the series of blower units.

### BACKGROUND OF THE INVENTION

This invention relates to centrifugal blowers and to fuel cells incorporating same.

Centrifugal blowers, or centrifugal fans, are a well known type of device for providing a flow or movement of a gaseous medium. A common type of centrifugal blower includes a housing having an axially directed gas inlet and a radially directed gas outlet, an impeller disposed within the housing for drawing gas at a first pressure into the inlet and expelling gas at a second higher pressure through the outlet and a motor for driving, i.e., spinning, the impeller. Variations of this general type of centrifugal blower are disclosed in, e.g., U.S. Pat. Nos. 4,917,572; 5,839,879; 6,877,954; 7,061,758; 7,351,031; 7,887,290; 7,891,942, and, U.S. 2006/0051203, the entire contents of which are incorporated by reference herein.

Centrifugal blowers in single unit and multiple independent unit configurations have been disclosed as components of cooling systems for computers, servers and other heat-generating electrical and electronic devices and equipment. See, e.g., U.S. Pat. Nos. 6,525,935; 7,184,265; 7,744,341; 7,802,617; 7,864,525; 7,885,068; 7,948,750; 7,902,617; and, 7,885,068, the entire contents of which are incorporated by reference herein.

Centrifugal blowers of the general type referred to above have been disclosed as components of fuel cells, of both the polyelectrolyte membrane (PEM) and solid oxide fuel cell (SOFC) types, where they function in one or more capacities, e.g., providing a flow of an oxidizer-containing gas such as air to the cathode elements of the fuel cell assembly and/or a flow of gaseous or vaporized fuel to its anode elements, recycling unspent fuel to the anode elements of the fuel cell assembly, providing a stream of cool air for cooling the fuel cell assembly or providing a stream of hot gas for vaporizing a liquid fuel prior to the external or internal reforming of the fuel to provide hydrogen for the operation of the fuel cell assembly. Fuel cell-blower assemblies featuring one or more centrifugal blowers are described in, e.g., U.S. Pat. Nos. 6,497,971; 6,830,842; 7,314,679 and 7,943,260, the entire contents of which are incorporated by reference herein.

Centrifugal blower systems containing more than one centrifugal blower have been disclosed by the applicant. Centrifugal blower systems and fuel cell-blower assemblies featuring one or more centrifugal blowers are described in, e.g., U.S. Pat. Nos. 9,017,893; 9,512,846; 9,593,686; and 10,273,961, U.S. Patent Application Publication No. 2018/00509007 and WO 2019055472, the entire contents of all of which are incorporated by reference herein.

### SUMMARY OF THE INVENTION

In accordance with the present invention, there is provided a centrifugal blower comprising: a series of blower units, each blower unit in the series comprising a casing having an axial inlet and a radial outlet, an impeller disposed within the casing for drawing a gaseous medium at a first pressure into the axial inlet and expelling gaseous medium at a second higher pressure through the radial outlet and a motor for driving the impeller; and, a duct connecting the radial outlet of at least one blower unit in the series of blower units with the axial inlet of at least one other blower unit in the series of blower units, wherein the axial inlet of the at least one blower unit in the series of blower units is positioned substantially opposite to the axial inlet of the at least one other blower unit in the series of blower units.

Further in accordance with the present invention there is provided a fuel cell comprising a fuel cell assembly comprising a plurality of individual fuel cells each fuel cell having an electrolyte medium, a cathode and an anode; and, at least one centrifugal blower system, described supra, for providing a flow of gaseous medium to the fuel cell assembly.

The novel features and advantages of the centrifugal blower system herein with its capability for increasing pressure of gaseous medium in the centrifugal blower system as compared to previous centrifugal blower systems, and a fuel cells incorporating such centrifugal blower systems to drive gaseous flow therein, as well as its ability to employ compact packing, will become more apparent from the following detailed description and accompanying drawings.

### BRIEF DESCRIPTION OF THE DRAWINGS

FIG. 1 illustrates, a perspective view of a dual blower system of the invention;

FIG. 1A illustrates the positioning of the blower unit 11 in an inverted position in FIG. 1;

FIG. 1B-1E illustrate the positioning of the two radial outputs of the centrifugal blower system in positions of 0°, 90°, 180° and 270° to each other;

FIG. 2 illustrates a top view of the dual blower system of FIG. 1;

FIG. 3 illustrates, a side view of the dual blower system of FIG. 1;

FIG. 4 illustrates a side view of the air intake assembly;

FIG. 5 illustrates a side cut-away view of the dual blower system of FIG. 1;

FIGS. 6A-6C illustrates, respectively, a side view of the view of an outlet of a blower in the dual blower system, an outlet of a blower having a circular flow straightener, and an outlet of the blower having a channel flow straightener.

FIGS. 7A and 7B illustrate, respectively, a perspective view of the bottom and top of two mechanically connected dual blower systems of the invention;

FIGS. 8A and 8B illustrate, respectively, a perspective view of the two mechanically connected dual blower systems of FIGS. 7A and 7B, showing the radial outlets directly adjacent to the radial inlets of the preceding blowers;

FIGS. 9A and 9B illustrate, respectively, a top and bottom view of two mechanically connected dual blower systems of the invention;

FIGS. 10A and 10B illustrate, respectively, a perspective view of the two mechanically connected dual blower systems of FIGS. 9A and 9B, showing the radial outlets directly adjacent to the radial inlets of the preceding blowers;

FIG. 11 is a diagrammatic illustration of a chemical reactor containing a fuel cell in accordance with the present teachings;

FIG. 12A is diagrammatic illustration of a blower control system for a dual blower system containing the dual blower system of FIG. 1;

FIG. 12B is a logic flow diagram for the dual blower control system of FIG. 1;

FIGS. 13A and 13B illustrate, respectively, perspective and plan views of a tubular SOFC assembly possessing separate dual blower systems of the invention for providing, respectively, air and fuel flow to the assembly; and,

FIG. 13C is a diagrammatic illustration of a cross section of an individual tubular fuel cell in the tubular SOFC assembly of FIGS. 13A and 13B.

### DETAILED DESCRIPTION OF THE INVENTION

The centrifugal blower system herein, employing axial inlets of two different blowers in the system positioned substantially opposite to each other, e.g., the orientation of the axial inlets of the two different blower is such that the direction of flow of gaseous medium into the two respective axial inlets is in opposite directions. As compared to centrifugal blower systems which have two different axial inlets positioned in substantially the same direction, the centrifugal blower system herein offers several advantages. In addition, these advantages are further enhanced when the centrifugal blower system of the present invention has the radial outlets of two different blowers in such a centrifugal blower system positioned substantially opposite to each other, e.g., wherein the orientation of the two different radial outlets is such that the direction of flow of gaseous medium out of the two respective radial outlets is in opposite directions.

It is to be understood that the present teachings herein are not limited to the particular procedures, materials and modifications described and as such can vary. It is also to be understood that the terminology used is for purposes of describing particular embodiments only and is not intended to limit the scope of the present teachings which will be limited only by the appended claims.

Throughout the specification and claims, where structures, devices, apparatus, compositions, etc., are described as having, including or comprising specific components, or where methods are described as having, including or comprising specific method steps, it is contemplated that such structures, devices, apparatus, compositions, etc., also consist essentially of, or consist of, the recited components and that such methods also consist essentially of, or consist of, the recited method steps.

In the specification and claims, where an element or component is said to be included in and/or selected from a list of recited elements or components, it should be understood that the element or component can be any one of the recited elements or components, or the element or component can be selected from a group consisting of two or more of the recited elements or components. Further, it should be understood that elements and/or features of a structure, device, apparatus or composition, or a method described herein, can be combined in a variety of ways without departing from the focus and scope of the present teachings whether explicit or implicit therein. For example, where reference is made to a particular structure, that structure can be used in various embodiments of the apparatus and/or method of the present teachings.

The use of the terms “include,” “includes,” “including,” “have,” “has,” “having,” “contain,” “contains,” or “containing,” including grammatical equivalents thereof, should be generally understood as open-ended and non-limiting, for example, not excluding additional unrecited elements or steps, unless otherwise specifically stated or understood from the context.

The use of the singular herein, for example, “a,” “an,” and “the,” includes the plural (and vice versa) unless specifically stated otherwise.

Where the use of the term “about” is before a quantitative value, the present teachings also include the specific quantitative value itself, unless specifically stated otherwise. As used herein, the term “about” refers to a ±10% variation from the nominal value unless otherwise indicated or inferred.

It should be understood that the order of steps or order for performing certain actions is immaterial so long as the present teachings remain operable. For example, the methods described herein can be performed in any suitable order unless otherwise indicated herein or otherwise clearly contradicted by context. Moreover, unless steps by their nature must be conducted in sequence, they can be conducted simultaneously.

At various places in the present specification, numerical values are disclosed as ranges of values. It is specifically intended that a range of numerical values disclosed herein include each and every value within the range and any subrange thereof. For example, a numerical value within the range of from 0 to 20 is specifically intended to individually disclose 0, 1, 2, 3, 4, 5, 6, 7, 8, 9, 10, 11, 12, 13, 14, 15, 16, 17, 18, 19 and 20 and any subrange thereof, for example, from 0 to 10, from 8 to 16, from 16 to 20, etc.

The use of any and all examples, or exemplary language provided herein, for example, “such as,” is intended merely to better illuminate the present teachings and does not pose a limitation on the scope of the invention unless claimed. No language in the specification should be construed as indicating any non-claimed element as essential to the practice of the present teachings.

Terms and expressions indicating spatial orientation or attitude such as “upper,” “lower,” “top,” “bottom,” “horizontal,” “vertical,” and the like, unless their contextual usage indicates otherwise, are to be understood herein as having no structural, functional or operational significance and as merely reflecting the arbitrarily chosen orientation of the various views of liquid fuel CPOX reformers of the present teachings illustrated in certain of the accompanying figures.

The term “substantially” as used herein takes into account minor variations in terms of positioning of various components herein, e.g., the axial inlets and/or the radial outlets.

The expression “opposite” as used herein with regard to various components, e.g., the axial inlets, can be understood to mean that the axial inlets are positioned such that the direction of flow gaseous medium into the one of the axial inlets of a blower unit is in the opposing direction as compared to the direction of flow of gaseous medium into another axial inlet of another blower unit in the centrifugal blower system described herein, but in one embodiment, such use of the term “opposite” does not encompass wherein the directions of flow of gaseous medium into the respective axial inlets are such that the axial inlets are directly facing each other.

The variance in positioning as is understood herein with regard to the term “substantially” in the expression “substantially opposite”, is in one embodiment understood to mean, that the positioning of an axial inlet in one blower unit is such that when compared to the positioning of an axial inlet of another blower unit in the series, e.g., a successive blower unit, is such that the positioning of the two axial inlets are about 180° to each other or allows for an angle of variance in positioning from a plane equidistant from the two axial inlet, which angle can be up from 1° up to about 20°, and preferably from 1° up to about 10° from the surface of the plane. This angle can apply to the positioning of one or both of the axial inlets.

The expression “substantially opposite to each other” as regards the radial outlet of one blower unit as compared to the radial outlet of another blower unit in the centrifugal blower system herein, e.g., a successive blower unit in the series, is understood to be similar to that described herein above as regards the axial inlets. Specifically, that the radial outlets are orientated such that the positioning of the two radial outlets are about 180° to each other or the orientation allows for an angle of variance in positioning from a plane equidistant from the two radial outlets, which angle can be up from 1° up to about 20°, and preferably from 1° up to about 10° from the surface of the plane. This angle can apply to the positioning of one or both of the radial outlets.

The expression “fuel cell” as used herein shall be understood as designating a device in which an electrochemically oxidizable fuel is made to undergo electrochemical reaction with oxidizing agent to produce an oxidized gas and a flow of electrical current.

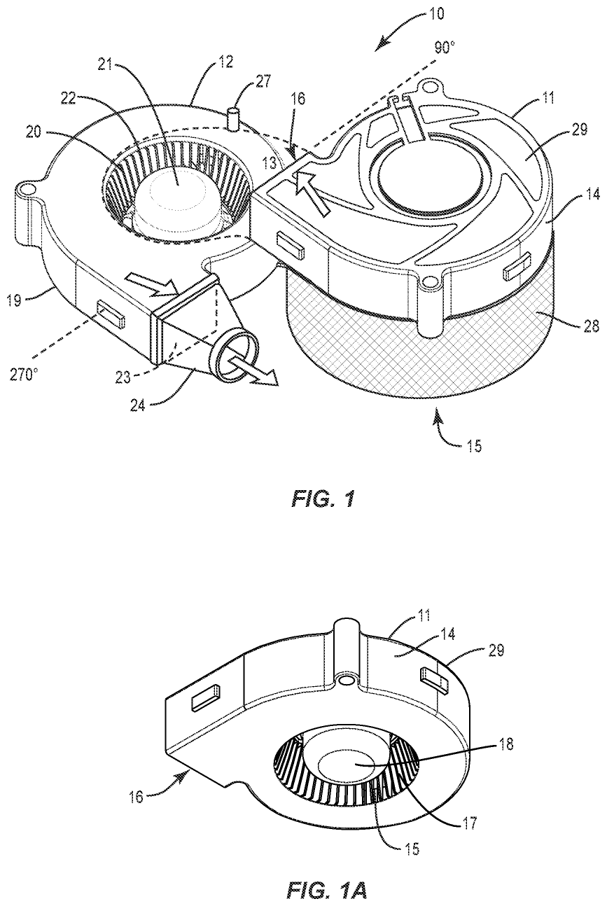

Referring to FIGS. 1 and 1A, in one embodiment of the centrifugal blower system of the invention, dual centrifugal blower system 10 includes a first centrifugal blower unit 11 connected to a second centrifugal blower unit 12 through duct 13. First blower unit 11 includes a casing 14 having an axial inlet 15 and a radial outlet 16, an impeller 17 disposed within casing 14 for drawing a gaseous medium at a first pressure into axial inlet 15 and expelling gaseous medium at a second higher pressure through radial outlet 16 and an electric motor 18 for driving impeller 17. Second blower unit 12 includes a casing 19 and, as shown by the illustration of duct 13 in FIG. 1 as transparent, an impeller 20 is disposed within casing 19 and driven by electrical motor 21 and an axial inlet 22 for receiving gas medium discharged from outlet 16 of first blower unit 11. Second blower unit further includes a radial outlet 23 and an optional outlet gas stream housing 24.

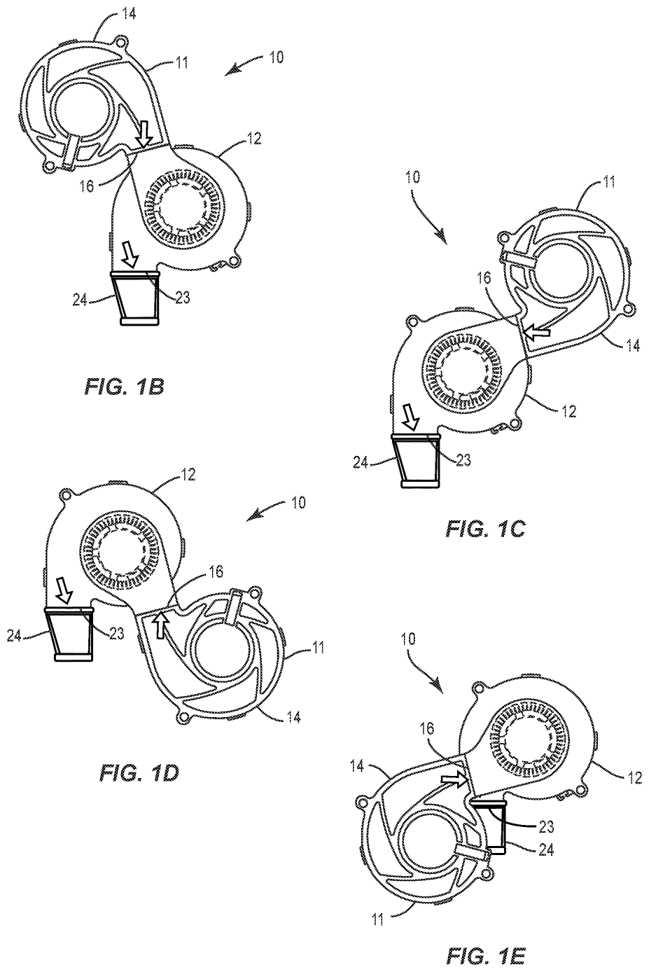

The arrows in FIG. 1 and in the other embodiments of the invention illustrated in other figures herein indicate the general direction of the gas stream through the radial outlet of each blower unit in the series of blowers constituting the blower system. As shown, e.g., in FIG. 1, the trajectory of the gas stream expelled through outlet 16 of first blower unit 11 and the trajectory of the gas stream expelled through outlet 23 of second blower unit 12 are not parallel to their respective outlets but are at some angle thereto. By arranging the geometry of duct 13 to receive the gas stream discharged through outlet 16 in such a manner that the stream remains approximately parallel to the interior walls of the duct, it is possible to prevent or reduce the turbulence that would otherwise occur were the stream to impinge upon these walls. Turbulence is advantageously minimized or avoided so as to reduce or eliminate it as a source of back pressure in the blower system. For this same reason, it is advantageous to arrange the angle of gas stream housing 24 so that its interior walls will be approximately parallel to the trajectory of the gas stream discharged through outlet 23 of second blower unit 12. The optimum geometry of the interior walls of duct 13 relative to the trajectory of its gas stream and the angle of offset of gas stream housing 24 can be readily determined for a given gas blower system employing routine experimentation. In the gas blower system shown in FIGS. 1-3, interior, or guiding, surfaces of duct 13 and interior, or guiding, surfaces of gas stream housing 24 can be pitched at an angle α of from 12° to 20°, and preferably from 14° to 18°, relative to outlets 16 and 23.

As shown in FIG. 1 the direction of flow of gaseous medium into the axial inlet 15 shown in the main figure by the directional arrow to 15 which corresponds to the location of axial inlet 15 more clearly identified in the smaller image below the main figure, is substantially opposite to the direction of flow of gaseous medium into the axial inlet 22. In addition, in a more preferable embodiment, the direction of flow of gaseous medium out of outlet 16 as compared to the direction of flow of gaseous medium out of outlet 23 are substantially opposite to each other due to the orientation of outlet 16 being substantially opposite to the orientation of outlet 23.

Referring to FIGS. 1-3, the duct 13 described herein has a gas flow-confining wall 25 enclosing an internal gas flow passageway 26 and a gas inlet, or port, 27 for admitting a gas into the gas flow passageway 26. The inlet 27 can provide for the introduction of a different gaseous medium which can mix with the previous gaseous medium provided through axial inlet 15 in the duct 13.

The two gaseous media will undergo some initial mixing within duct 13 the extent of which will depend on the degree of turbulence resulting from the merger of the two gas streams. This initial mixture of gaseous media within duct 13 then enters second blower unit 12 where thorough mixing takes place, the substantially uniform mixture of gases then being discharged from radial outlet 23 and routed to where needed.

Inlet 27 can, for example, be provided as one or more apertures in the wall of duct 13 or it can extend beyond such wall so as to introduce second gaseous medium further within gas flow passageway 26 of duct 13, for example, at or near the center of gas flow therein. In the case of the latter embodiment, the section of inlet 27 extending into the gas flow passageway 26 can be provided with a streamlined cross section in order to minimize turbulent flow. The section of inlet 27 extending into the gas glow passageway 26 of duct 13 can be oriented in any suitable direction and/or attitude, for example, one which favors a more parallel, and therefore less turbulent, merger of the separate gaseous streams.

The embodiments of the centrifugal blower system of FIGS. 1B-1E are similar in structure to the centrifugal blower system illustrated in FIG. 1 including the orientation of the radial outlet 23 of second blower unit 12 relative to the radial outlet 16 of first blower unit 11. In the blower system of FIG. 1, the angle of orientation is preferably about 180°. This angle can also be about 0°, 90°, or 270°. All orientation angles are, of course, contemplated with the optimum angle of orientation for a given centrifugal blower system being made to depend upon the specific use to which the blower system is to be put.

Another angle of significance in the centrifugal blower system of the invention is the angle of pitch of the radial outlet 16 of the first blower 11 relative to the axial inlet 21 of the second blower. In the embodiments of blower systems illustrated in FIGS. 1-3, the approximate angle is 0°. As in the case of the blower unit orientation angles referred to above, these blower pitch angles can assume values throughout the entire range of 0°-270°, again, with the optimum pitch value of a given blower system depending on specific application requirements.

Thus far, dual centrifugal blower systems have been disclosed with the output of the first blower being introduced into the inlet of the second blower and with each of the blowers having about the same range of gas pressure and gas flow output capability. The basic configuration of dual blower systems can be represented as “1 into 2” meaning that gas discharged from the first blower is introduced into the inlet of the second blower. However, as those skilled in the art will readily recognize, numerous other arrangements are within the scope of this invention.

Other embodiments of the centrifugal blower system herein include those with three, four and even a greater number of blower units, those in which the discharge from two or more blowers is introduced into the inlet of a single blower and those in which the discharge of a single blower is introduced into the inlets of two or more blowers. Blower systems of the foregoing kind can be designated, e.g., “1 into 2 into 3”, etc., where the gas discharge stream of a preceding blower unit is ducted into the inlet of the following blower unit in the series, “1 and 2 into 3”, etc., where the discharged streams of first and second blower units are commonly ducted into the inlet of a third blower unit and “1 into 2 and 3” where the discharge stream of a first blower unit is ducted into second and third blower units. In blower systems in which a gas stream of one blower is combined with the gas stream of another blower or a single blower stream is divided into two separate streams, valving may be provided to regulate the various gas flows in these systems.

In the centrifugal blower system herein, the gas discharged from each of blower units is introduced via the duct 13 into the inlet of the successive blower unit. Centrifugal blower system 10 is therefore an example of the “1 and 2 into 3” configuration referred to above. This configuration enables control to be achieved whereby the gas flow capability of a single relatively large blower is obtained with the quick response characteristics of several smaller blowers. Examples of such configurations are provided in U.S. Pat. No. 9,512,846, the entire contents of which are incorporated by reference herein.

The centrifugal blower system 10 with the output of single blower unit being introduced into successive blower units via a common duct 13, is an example of a “1 into 2 and 3” arrangement of blower units. This configuration of blower units enables use of a single primary gas pressure and gas flow supply blower with individual blowers downstream to provide more accurate control of two separate gas discharge streams. Examples of such configurations are provided in U.S. Pat. No. 9,512,846.

In one embodiment, the discharge stream from a first blower unit of a triple blower system is introduced via duct 13 into a second blower unit with the discharge stream of the second blower unit being introduced via a further duct 13 into a third blower unit, such illustrating the “1 into 2 into 3” configuration referred to above, as is described in U.S. Pat. No. 9,512,846. This successive arrangement of three blowers permits the second and third blowers to quickly and accurately respond to target gas pressure and gas flow requirements the greater part of which are provided by the first blower unit.

Further included within the scope of this invention are those centrifugal blower systems in which one or more blower units differ from one or more others in the system in their range of gas pressure and gas flow output capability. Such an embodiment of gas blower system is illustrated in U.S. Pat. No. 9,512,846. For example, a dual centrifugal gas blower system can possess a first blower unit of relatively large gas pressure and gas flow capability with the gas stream expelled therefrom being introduced via a duct 13 into a smaller blower unit. This arrangement of blowers of differing size enables fine adjustment of higher gas flow rates. Where gas flow requirements exceed that which can be achieved with a blower system in which the blower units are of approximately the same capability, the larger capacity blower unit can be supplemented by the lower capacity unit. This permits a greater range of gas flow while still realizing the quicker and more accurate flow control characteristics of the centrifugal blower system of this invention.

In all of the centrifugal blower systems of the invention, the individual blower units, their interconnecting duct(s) aside, need not be in direct contact with each other but can be separated by a distance. Placing one or more blowers in the blower system of the invention at a separate location can be of advantage when optimal packaging considerations for a particular application favor such an arrangement.

The dimensions, voltage, power draw, impeller speed, air flow, noise level as well as other characteristics of a particular blower unit utilized in the centrifugal blower system of the invention can vary widely depending on gas pressure and gas flow requirements and end-use application. The following table lists some typical characteristics for a range of useful blower units:

| | | | | | | Static | | |
|---|---|---|---|---|---|---|---|---|
| | Rating | Power | Power | | Air | Pressure | | |
| Size | Voltage | Current | Consumption | Speed | Flow | (Inch- | Noise | Weight |
| (mm) | (VDC) | (AMP) | (WATTS) | (RPM) | (CFM) | Water) | (dBA) | (g) |
| 35 × 35 × 7 | 12 | 0.065 | 0.8 | 6300 | 0.9 | 0.27 | 22.2 | 8 |
| 45 × 45 × 20 | 12 | 0.04 | 0.48 | 3500 | 4.6 | 0.22 | 21 | 22.64 |
| 50 × 50 × 15 | 12 | 0.17 | 2.2 | 6000 | 4.7 | 0.97 | 42.2 | 30 |
| 50 × 50 × 15 | 12 | 0.1 | 1.2 | 5000 | 4.0 | 0.67 | 39.8 | 30 |
| 50 × 50 × 15 | 12 | 0.06 | 0.7 | 4000 | 3.0 | 0.40 | 33.4 | 30 |
| 50 × 50 × 15 | 12 | 0.044 | 0.5 | 3000 | 2.3 | 0.16 | 27 | 30 |
| 50 × 50 × 20 | 12 | 0.124 | 1.5 | 5200 | 5.7 | 0.66 | 35 | 33 |
| 50 × 50 × 20 | 12 | 0.104 | 1.3 | 4800 | 5.2 | 0.56 | 33 | 33 |
| 50 × 50 × 20 | 12 | 0.088 | 1.1 | 4400 | 4.8 | 0.46 | 30 | 33 |
| 60 × 60 × 15 | 12 | 0.105 | 1.3 | 4800 | 5.2 | 0.44 | 40.5 | 45 |
| 60 × 60 × 15 | 12 | 0.07 | 0.8 | 4200 | 4.7 | 0.32 | 36 | 45 |
| 60 × 60 × 15 | 12 | 0.04 | 0.5 | 3200 | 3.5 | 0.18 | 29 | 45 |
| 60 × 60 × 25 | 12 | 0.14 | 1.7 | 3600 | 7.3 | 0.58 | 32.4 | 55 |
| 75 × 75 × 30 | 12 | 0.3 | 3.6 | 3400 | 13.6 | 0.6 | 43.5 | 86.5 |
| 75 × 75 × 30 | 12 | 0.23 | 2.8 | 3000 | 12.3 | 0.48 | 40.5 | 86.5 |
| 75 × 75 × 30 | 12 | 0.13 | 1.5 | 2400 | 9.6 | 0.27 | 33.9 | 86.5 |
| 75 × 75 × 30 | 12 | 0.08 | 1.0 | 1900 | 7.5 | 0.15 | 28 | 86.5 |
| 75 × 75 × 30 | 24 | 0.17 | 4.1 | 3400 | 13.6 | 0.6 | 43.5 | 86.5 |
| 75 × 75 × 30 | 24 | 0.14 | 3.4 | 3000 | 12.3 | 0.48 | 40.5 | 86.5 |
| 75 × 75 × 30 | 24 | 0.08 | 1.9 | 2400 | 9.6 | 0.27 | 33.9 | 86.5 |
| 75 × 75 × 30 | 24 | 0.05 | 1.2 | 1900 | 7.5 | 0.15 | 28 | 86.5 |
| 97 × 97 × 33 | 12 | 560 | 6.7 | 3600 | 26.7 | 0.76 | 54.3 | 183 |
| 97 × 97 × 33 | 12 | 0.72 | 9.6 | 3600 | 30.5 | 0.92 | 55.8 | 185 |
| 97 × 97 × 33 | 12 | 0.56 | 6.7 | 3200 | 26.6 | 0.65 | 53.1 | 185 |
| 97 × 97 × 33 | 12 | 0.30 | 3.6 | 2700 | 22.4 | 0.43 | 50 | 185 |
| 97 × 97 × 33 | 24 | 0.39 | 9.4 | 3600 | 30.5 | 0.92 | 55.8 | 185 |
| 97 × 97 × 33 | 24 | 0.25 | 6.0 | 3200 | 26.6 | 0.65 | 53.1 | 185 |
| 97 × 97 × 33 | 24 | 0.16 | 3.8 | 2700 | 22.4 | 0.43 | 50 | 185 |
| 97 × 97 × 33 | 48 | 0.17 | 8.2 | 3600 | 30.5 | 0.92 | 55.8 | 185 |
| 97 × 97 × 33 | 48 | 0.13 | 6.2 | 3200 | 26.6 | 0.65 | 53.1 | 185 |
| 97 × 97 × 33 | 48 | 0.09 | 4.3 | 2700 | 22.4 | 0.43 | 50 | 185 |
| 120 × 120 × 32 | 12 | 755 | 9.06 | 2800 | 38.7 | 1.14 | 55.8 | 242 |
| 120 × 120 × 32 | 12 | 0.82 | 9.8 | 2500 | 35.9 | 0.89 | 53.8 | 250 |
| 120 × 120 × 32 | 12 | 0.45 | 5.4 | 2100 | 31.4 | 0.64 | 49.6 | 250 |
| 120 × 120 × 32 | 24 | 0.38 | 9.1 | 2500 | 35.9 | 0.89 | 53.8 | 250 |
| 120 × 120 × 32 | 24 | 0.24 | 5.8 | 2100 | 31.4 | 0.64 | 49.6 | 250 |
| 120 × 120 × 32 | 24 | 0.38 | 9.1 | 2500 | 35.9 | 0.89 | 53.8 | 250 |
| 120 × 120 × 32 | 24 | 0.24 | 5.8 | 2100 | 31.4 | 0.64 | 49.6 | 250 |
| 120 × 120 × 32 | 48 | 0.12 | 5.8 | 2100 | 31.4 | 0.64 | 49.6 | 250 |

It will, of course, be recognized that the invention is not limited to blower units possessing the forgoing characteristics but can utilize any centrifugal blower unit having lesser or greater dimensions, voltage and power requirements, impeller rpm, gas pressure and gas flow capabilities, etc., than those listed in the table.

Referring to FIGS. 1-3, in one embodiment herein, the centrifugal blower system as described herein, can have a greater second higher pressure expelled from the radial outlet 16 than a second higher pressure expelled from the radial outlet in a centrifugal blower system that is outside the scope of the present invention, e.g., a centrifugal blower system in which the axial inlet of at least one blower unit in the series of blower units positioned in the substantially same direction to the axial inlet of at least one other blower unit in the series of blower units. The foregoing comparison of a centrifugal blower system outside the scope of the present invention is such that it corresponds to the centrifugal blower system herein, i.e., it is the same as that described herein, except that the axial inlet of at least one blower unit in the series of blower units positioned in the substantially same direction to the axial inlet of at least one other blower unit in the series of blower units.

While not wishing to be bound by theory it is believed that the positioning of the axial inlet 15 substantially opposite to axial inlet 21 allows for less resistance to the flow of gaseous medium in duct 13 than occurs when the positioning of the axial inlet corresponding to axial inlet 15 herein is in the substantially the same direction to the axial inlet corresponding to axial inlet 21 herein, such as those comparative corresponding axial inlet positions are described in U.S. Pat. No. 9,512,846.

The greater second higher pressure can vary depending on various parameters of the centrifugal blower system such as those described herein, such as, for example, the percent of the duty cycle of the blower system being employed. In one non-limiting embodiment herein, the greater second pressure can be from about 1% greater to about 10% greater, preferably from about 3% greater to about 7% greater than the second higher pressure in a centrifugal blower system in which the axial inlet of at least one blower unit in the series of blower units positioned in the substantially same direction to the axial inlet of at least one other blower unit in the series of blower units.

The following table provides a comparison of the measurements of static pressure in a centrifugal blower system wherein the axial inlets are opposing in orientation (the present inventions) as compared to wherein the axial inlets are matching in orientation.

| | Opposing Axial Inlet | Matching Axial Inlet |
|---|---|---|
| | Orientation | Orientation |
| | Static Pressure (inwc) | Static Pressure (inwc) |
| Duty Cycle | (Present Invention) | (Comparative Example) |
| 95 | 3.23 | 3.03 |
| 90 | 3.21 | 3.01 |
| 80 | 3.16 | 2.96 |
| 70 | 3.1 | 2.93 |
| 60 | 3.02 | 2.83 |
| 50 | 2.87 | 2.71 |
| 40 | 2.65 | 2.52 |
| 30 | 2.3 | 2.18 |
| 20 | 1.7 | 1.64 |
| 10 | 0.74 | 0.74 |
| 0 | 0 | 0 |

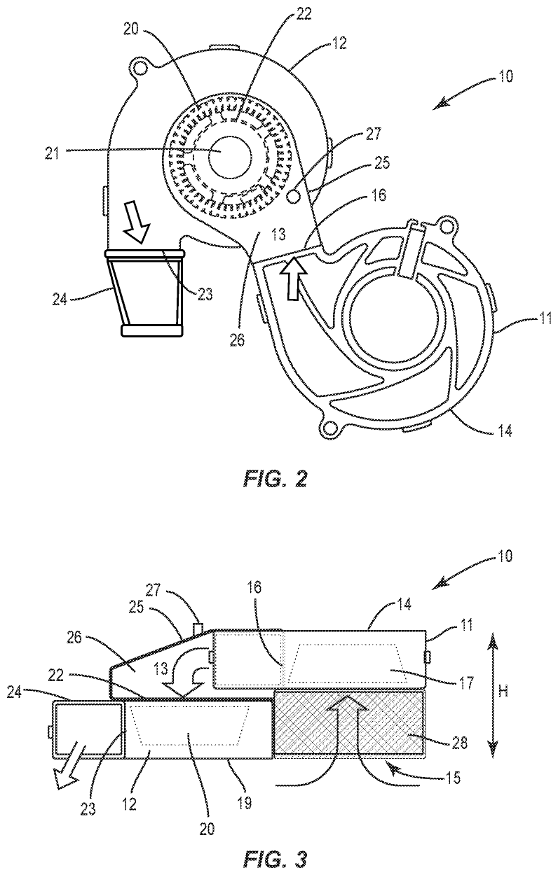

In addition to the present invention providing for a greater second higher pressure in the centrifugal blower system described herein, another advantage of the present invention is that the centrifugal blower system described herein provides for condensed packaging as compared to the centrifugal blower system of the prior art which is wherein the axial inlet one of one blower unit in centrifugal blower system is positioned in substantially the same direction to the axial inlet of at least one other blower unit in the series of blower units. This is most readily appreciated when viewing the present invention as detailed in FIGS. 1 and 3 herein.

In the embodiment illustrated in FIGS. 1 and 3, the first blower unit 11 has an air filter 28 over the axial inlet 15. In another embodiment, (not shown), the first blower unit 11 can have an air intake assembly as described herein below over the axial inlet 15, alone or in combination with the air filter 28. As seen in FIGS. 1 and 3, the placement of the air filter 28 over the axial inlet 15 in the current configuration of axial inlet 15 of first blower unit 11 being positioned substantially opposite to axial inlet 21 of second blower unit 12 provides for a combined height H of the first blower unit 11 and the second blower unit 12. In contrast, in the invention of the prior art, such as that described in U.S. Pat. No. 9,512,846, the orientation of the axial inlet of the first blower unit in substantially the same direction as the axial inlet of the second blower unit, i.e., an inversion of the first blower unit 11 of the present invention, would result in a corresponding height which is greater than that provided in the present invention due to the presence of the air filter and/or air intake which is used over the first axial inlet. The present invention provides for a centrifugal blower system 10 which has a height H which is less than a height of a corresponding centrifugal blower system which has the axial inlet of a blower unit in the series of blower units, e.g., a first blower unit, positioned in substantially the same direction to the axial inlet of at least one other blower unit in the series of blower units, e.g., a second blower unit in the series.

While the height H can vary upon the parameters of the centrifugal blower system 10 described herein, generally the height H is from 1% to 50% less in height, preferably from 1% to about 40% less in height, and most preferably from 1% to 30% less in height, than a prior art centrifugal blower system which has the axial inlet of a blower unit in the series of blower units, e.g., a first blower unit, positioned in substantially the same direction to the axial inlet of at least one other blower unit in the series of blower units, e.g., a second blower unit in the series.

Further in accordance with the present invention there is provided a centrifugal blower system comprising an air intake assembly which comprises an air intake assembly casing having an air inlet and an air outlet, the air outlet connectable to an axial inlet of one blower casing of one centrifugal blower in the series of blower units; a check valve mounted within the air intake assembly casing positioned to permit air flow from the air inlet through the air intake assembly casing to the air outlet and prevent air flow from the air outlet through the air intake assembly casing to the air inlet.

The air intake assembly for the centrifugal blower system herein offers several advantages over the prior art centrifugal blowers, particularly when incorporated in a fuel cell or fuel reformer for managing the flow of gaseous media therein. Filtration of the incoming air before the check valve can be used to filter particulates, volatile compounds, sulfur compounds from environment, and can include a desiccant to reduce moisture. Filtration of the incoming air after the check valve can be used to filter particulates, volatile compounds, sulfur compounds from environment, and can include a desiccant to reduce moisture. The check valve prevents zero flow conditions from getting back flow from fans and other process air. At high temperatures, this can damage the solid oxide fuel cell (SOFC) and catalysts by oxidation. The present invention can prevent this from occurring. The filter can be reticulated foam (low pressure drops) of some kind and potentially doped with specific materials to perform the tasks enumerated above. The check valve can be a flexible diaphragm made of a soft elastomer that induces very little pressure drop to open and uses the slight inherent stiffness and spring constant of the material to close and seal.

Utilizing the multiple blower system of this invention for meeting the gas flow requirements of a fuel cell enables the system to benefit from both low inertia impellers for control as well as low drive motor rpm and power draw to provide required gas flow and pressure.

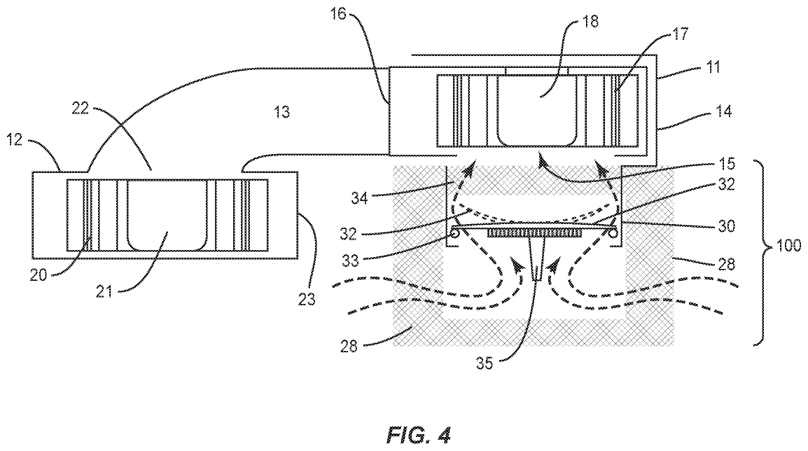

FIG. 4 illustrates the two blowers of FIGS. 1-3 of the dual centrifugal blower system 10 with air intake assembly 100 attached to axial inlet 15. Air intake assembly includes an air intake casing 30 mountable to blower casing 14. The drawings illustrate air intake casing 30 and blower casing 14 formed as a monolithic component. Although illustrated in this way, air intake casing 30 can be a separate unit from blower casing 14, which in turn are configured with means to attach air intake casing 30 to blower casing 14. This attachment can include screws, nuts and bolts, a formed key and slot assembly, a slot and tab assembly, a twist locking tab and groove assembly, etc., to secure air intake casing 30 to blower casing 14.

Air intake assembly 100 includes a frame (not shown), radial arms (not shown) and a flapper 32 and flapper connecting post 35 connected to flapper 32. Radial arms are connected at one end to the frame and meet in the center to form a receptacle to accept flapper connecting post 35. The frame can be held in place via compression using O-ring 33. The air intake assembly 100 prevents zero flow conditions from getting back flow from fans and other process air, which at high temperatures can damage the solid oxide fuel cell (SOFC) and catalysts by oxidation. Although the air intake assembly 100 is described and illustrated as a flapper type check valve, other check valve assemblies are contemplated, for example, a ball check valve, a spring and piston check valve, etc.

Flapper 32 can be a soft elastomer that induces very little pressure drop to open and uses the slight inherent stiffness and spring constant of the material to close and seal. The movement is illustrated in FIG. 4 wherein in its closed position, flapper 32 is shown as a solid line, and in its open position, flapper 32 is shown as a dashed line. Flapper 32 opens when blowers are engaged and pull air in through axial inlet 15. When blowers are off or if the back pressure of the system causes air to flow in the direction opposite the arrows shown, flapper 32 closes to prevent the flow of air.

The filter assembly includes filter frame, filter 28, and O-ring 33. A top portion 34 of filter 28 is held by filter frame. In this embodiment filter frame is held in place via compression using O-ring 33. Filtration of the incoming air by the filter assembly after the check valve assembly can be used to filter particulates, volatile compounds, sulfur compounds, hydrocarbons, etc., desiccants to reduce moisture, active filtration media to remove air contaminants, etc. Filter 28 can be reticulated foam (low pressure drop) of some kind and potentially doped with specific materials to perform the tasks enumerated above, e.g. as a sulfur trap. The particle size that is filtered can range from 1-100 microns or beyond.

Although filter assembly is described having filter frame, filter 28, and O-ring 33, other embodiments are contemplated. For example, a single form-fitted foam can be fitted into place without the need for filter frame and O-ring 33.

The air intake assembly 100 with the check valve assembly and multiple filter assemblies attached to the centrifugal blower system 10 filters the incoming air before the check valve can be used to filter particulates, volatile compounds, and/or moisture.

In the embodiment of FIG. 4, an outer filter 31 can be attached over air intake assembly 100. Outer filter 31 can be flat or tubular in shape with the filter material extending across the lower end; the bottom end is open and sized to receive air intake assembly 100. When outer filter 31 is fitted onto air intake casing 30, air can flow through the top and partially along the sides of outer filter 28.

In FIG. 4, upper filter 34 is attached over air intake assembly 100 in a fashion similar to that of lower filter 31. Outer filter 34 can also be flat or tubular in shape. When upper filter 34 is fitted onto air intake casing 30, and positioned in an outer casing of a unit, for example a fuel cell, the inner surface of the casing 30 can be used to seal the upper open end of upper filter 34. Air can then flow only through and partially along the sides of upper filter 34.

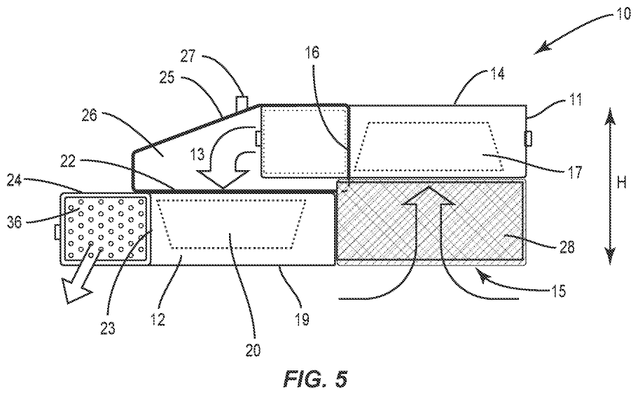

FIG. 5 is a side perspective view of a dual blower system of the present invention. As can be seen by the arrows in FIG. 5, a gaseous medium is taken in through axial inlet 15 of blower 11 after first passing through air filter 28 and/or air intake assembly 100, and then exits through radial outlet 16 into the duct 13 and then into axial inlet 22 of second blower 12. After this, the gaseous medium exits from radial outlet 23.

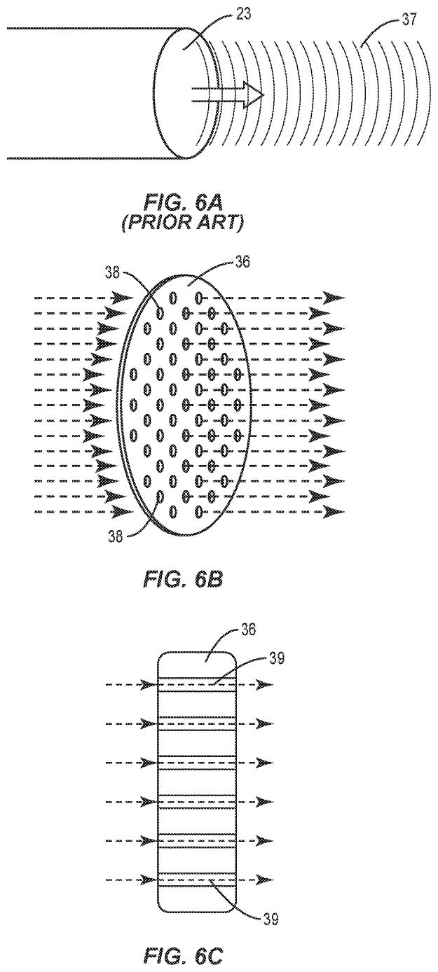

FIGS. 6A-6C describe the use of a flow straightener 36 which is located at the outlet 23 of the blower 12 and is illustrated in use in FIG. 5. Flow straightener 36 functions to reduce any turbulence 37 in the flow of gaseous medium as it exits radial outlet 23, as shown without the flow straightener in FIG. 6A. In FIG. 6B, the flow straightener 36 is shown with circular perforations 38 which function to straighten the flow of gaseous medium exiting the axial outlet 23. FIG. 6C illustrates the use of channels 39 which are rectangular in the flow straightener 36.

Referring to FIGS. 5, 11 and 12A, downstream of the flow straightener 36, and downstream at least one blower unit in the series, there is a flow sensing element or meter 404, which provides a sensory means of measurement of the flow exiting the radial outlet 23.

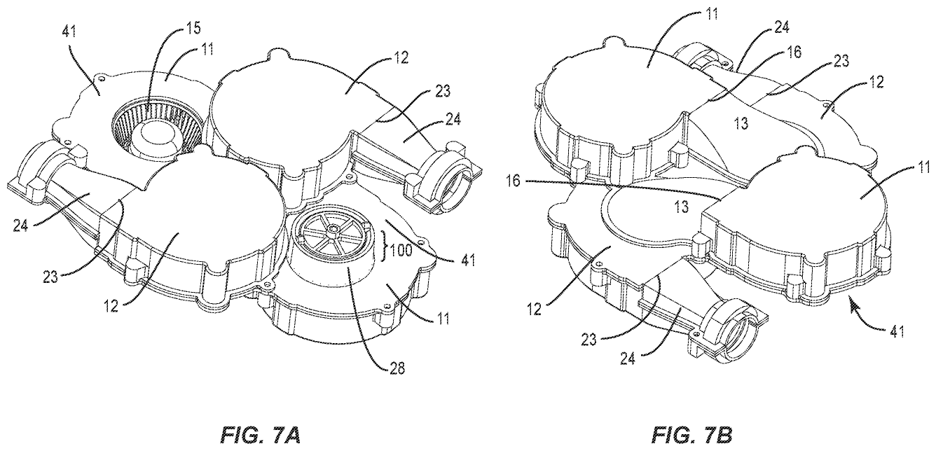

Referring to FIGS. 7A and 7B, there is illustrated therein a perspective bottom and top view, respectively of two mechanically connected blower unit pairs of individual blowers 11 and 12. The mechanical connection between the two blower unit pairs may be done by thermo-welding or molding or using any mechanical connection means, such as screws, bolts, adhesive. etc. As seen in FIGS. 7A and 7B the two blower unit pairs are substantially juxtaposed to each other, i.e., they are placed next to each other, but any variation or angling or shifting of the two blowers in each pair and/or the blower unit pairs as a whole is contemplated and can be adjusted by those skilled in the art. In one embodiment the two blower unit pairs can be juxtaposed to each other in the same plane.

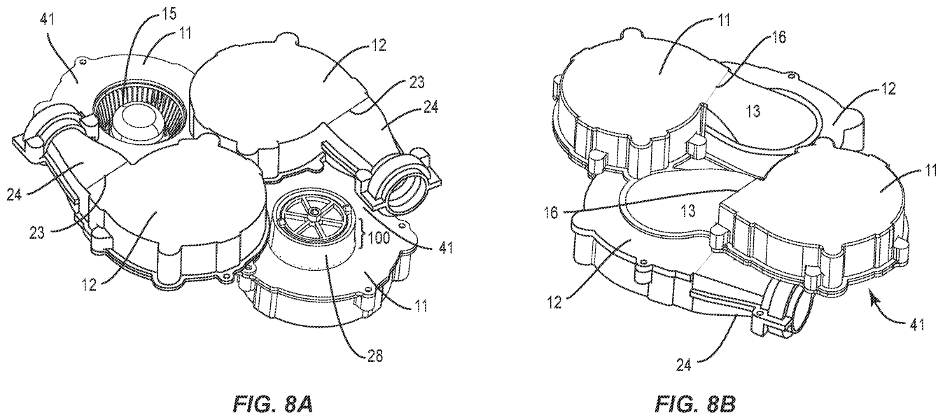

FIGS. 8A and 8B, illustrate the movement of the gas stream housing 24 of the blower unit 12 shown in FIGS. 7A and 7B but now tucked in below the bottom 41 of the blower unit 11.

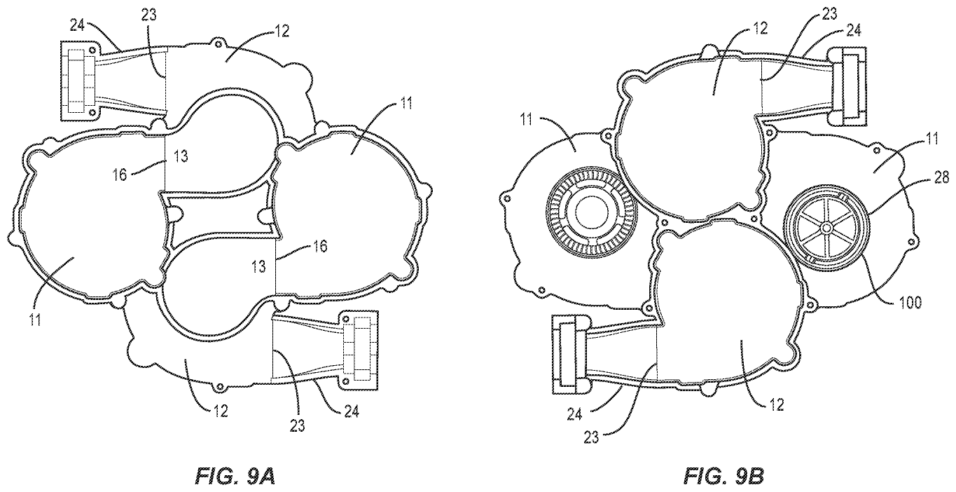

Referring to FIGS. 9A and 9B, there is illustrated therein an overhead, top and bottom view, respectively, of two mechanically connected blower unit pairs of individual blowers 11 and 12. As seen in FIGS. 7-8 the two blower unit pairs are substantially juxtaposed to each other, i.e., they are placed next to each other, but any variation or angling or shifting of the two blowers in each pair and/or the blower unit pairs as a whole is contemplated and can be adjusted by those skilled in the art.

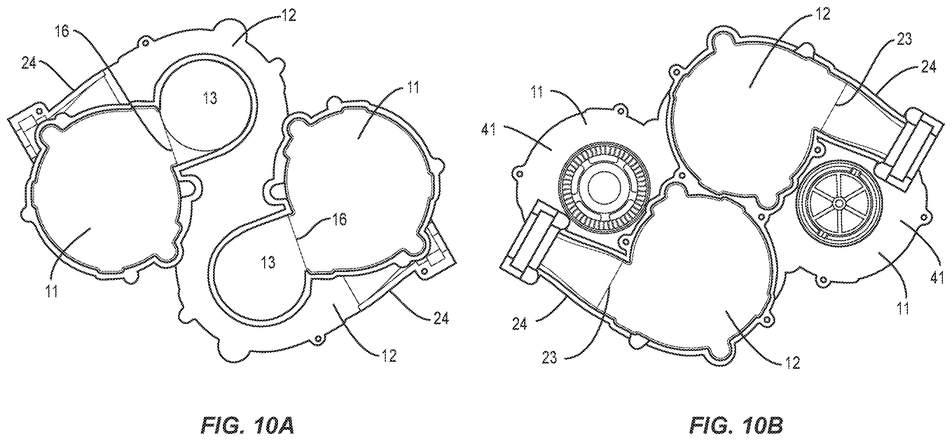

Specifically, in FIGS. 10A and 10B, illustrate the movement of the gas stream housing 24 of the blower unit 12 shown in FIGS. 9A and 9B but now tucked in below the bottom 41 of the blower unit 11.

Referring to FIGS. 7-10, the two mechanically connected blower unit pairs of individual blowers 11 and 12, can in one non-limiting embodiment have only one pair that contains an air filter 28 and/or an air intake assembly 100 as described herein. Such a choice of which of the two mechanically connected blower unit pairs of individual blowers 11 and 12 contain the air filter and 28 and/or an air intake assembly 100 can be determined by those skilled in the art, and in one embodiment can comprise wherein one pair is used to supply a gaseous medium to a reformer and one to fuel cells of a fuel cell system as described herein. In addition, the flapper 32 as shown in FIG. 4 can be used in only one of the pairs of the two mechanically connected blower unit pairs.

There is also provided herein a fuel cell comprising a fuel cell assembly comprising a plurality of individual fuel cells each fuel cell having an electrolyte medium, a cathode and an anode; and, at least one centrifugal blower system 10 as described herein for providing a flow of gaseous medium to the fuel cell assembly. In one embodiment the fuel cell is a solid oxide fuel cell, preferably a tubular solid oxide fuel cell assembly. The tubular solid oxide fuel cell assembly can include a first blower system 10 for providing fuel to the anode component of a tubular solid oxide fuel cell element and a second blower system 10 for providing a source of oxidizer gas to the cathode component of a tubular solid oxide fuel cell element.

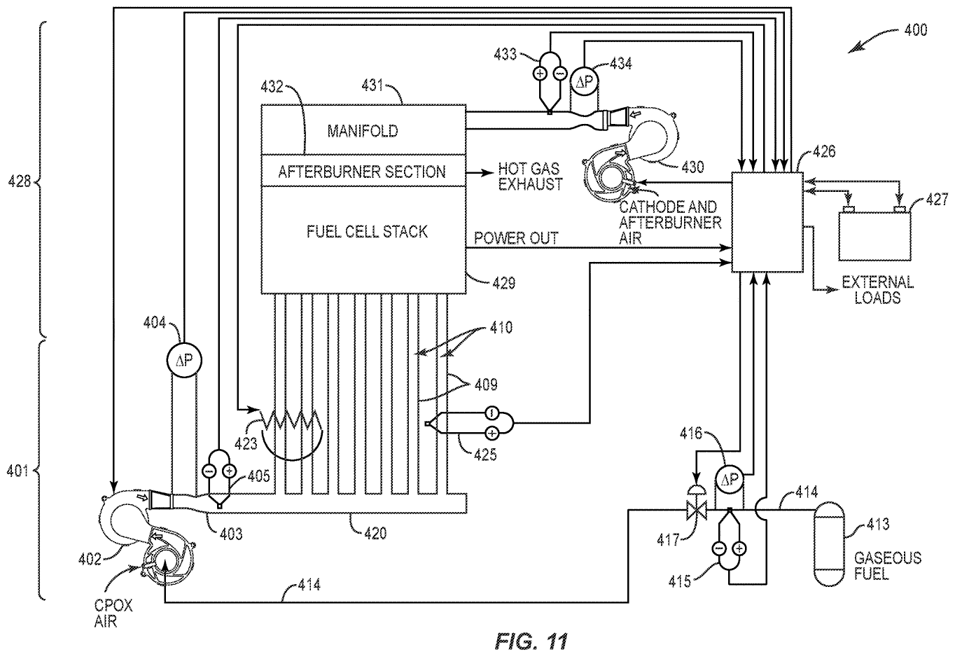

Referring to FIG. 11, integrated gaseous fuel CPOX reformer-fuel cell system 400 includes gaseous fuel CPOX reformer section 401 coupled to fuel cell section 428. Reformer section 401 includes dual, interconnected centrifugal blower system 402, for example, as illustrated in FIGS. 1-3, for introducing a mixture of air and gaseous fuel into conduit 403 and for driving this and other gaseous streams (inclusive of gaseous fuel-air mixture(s) and hydrogen-rich reformates) through the various gas flow passageways of the reformer and fuel cell sections. Conduit 403 can include flow meter 404 and thermocouple 405. These and similar devices can be placed at various locations within a gaseous fuel CPOX reformer section and fuel cell section in order to measure, monitor and control the operation of integrated reformer-fuel cell system 400.

In a start-up mode of operation of integrated gaseous fuel CPOX reformer-fuel cell system 400, a mixture of air and propane at ambient temperature is introduced by centrifugal blower system 402 into conduit 403. The propane is drawn into connecting duct 403 of centrifugal blower system 402 through inlet 406 at relatively low pressure from gaseous fuel storage tank 413 via fuel line 414 equipped with optional thermocouple 415, flow meter 416 and flow control valve 417. The air and propane are thoroughly mixed within centrifugal blower system 402 prior to the gas mixture being discharged therefrom and into conduit 403. The substantially homogeneous propane-air mixture (gaseous CPOX reaction mixture) enters manifold, or plenum, 420 which functions to distribute the reaction mixture more evenly into tubular CPOX reactor units 409.

In a start-up mode of operation of CPOX reformer section 401, igniter 423 initiates the CPOX reaction of the gaseous CPOX reaction mixture within CPOX reaction zones 410 of tubular CPOX reactor units 409 thereby commencing the production of hydrogen-rich reformate. Once steady-state CPOX reaction temperatures have been achieved (e.g., 240° C. to 1,100° C.), the reaction becomes self-sustaining and operation of the igniter can be discontinued. Thermocouple 425 is positioned proximate to one or more CPOX reaction zones 410 to monitor the temperature of the CPOX reaction occurring within CPOX reactor units 409. The temperature measurements can be relayed as a monitored parameter to reformer control system 426.

Reformer section 401 can also include a source of electrical current, for example, rechargeable lithium-ion battery system 427, to provide power, for example, during start-up mode of operation of integrated reformer-fuel cell system 400 for its electrically driven components such as centrifugal blower system 402, flow meter 404, flow control valve 417, igniter 423, and, if desired, to store surplus electricity, for example, produced by fuel cell section 428 during steady-state operation, for later use.

Fuel cell section 428 includes fuel cell stack 429, an afterburner, or tail gas burner, 432, centrifugal blower system 430 for introducing air, evenly distributed by manifold 431, to the cathode side of fuel cell stack 429 to support the electrochemical conversion of fuel to electricity therein and to afterburner 432 to support combustion of tail gas therein, and optional thermocouple 433 and flow meter 434 to provide temperature and pressure measurement inputs to control system 426. Hydrogen-rich reformate produced in gaseous CPOX reformer section 401 enters fuel cell stack 429 and undergoes electrochemical conversion therein to electricity and by-product water (steam) and carbon dioxide as gaseous effluent. This gaseous effluent, or tail gas, from fuel cell stack 429 can contain combustibles gas(es), for example, hydrocarbon(s), unconsumed hydrogen, and/or other electrochemically oxidizable gas(es) such as carbon monoxide, which then enter afterburner 432 where their combustion to water (steam) and carbon dioxide takes place utilizing air provided by centrifugal blower system 430. If desired, heat contained in the hot gas exhaust from afterburner 432 can be recovered and utilized to heat one or more fluid streams, for example, to change water to steam for use in ATR and/or SR reforming.

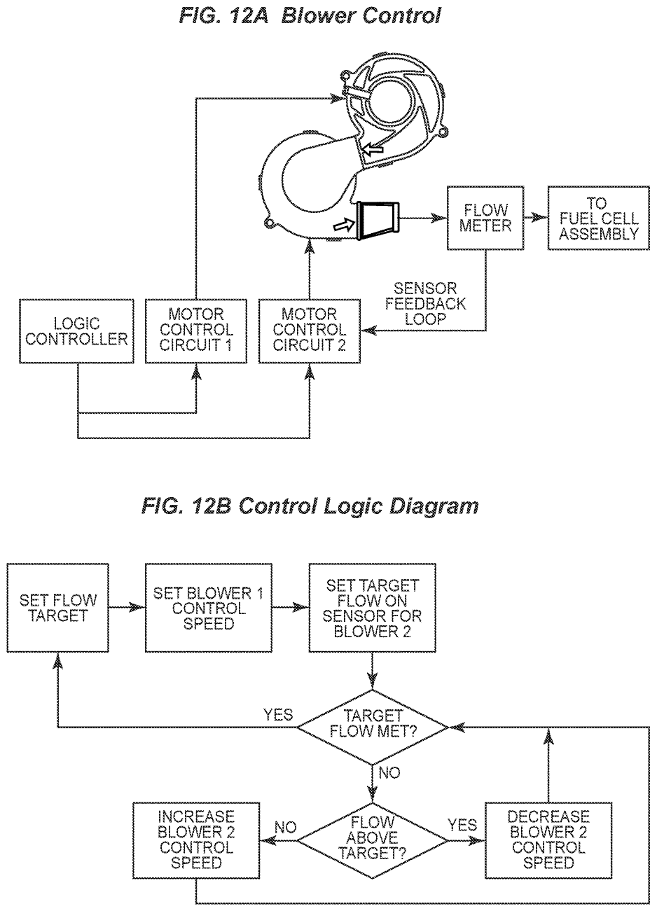

The centrifugal blower system 10 described herein can contain a blower control system FIG. 12A of a centrifugal blower system of the invention and a diagrammatic representation of its control logic FIG. 12B. As those skilled in the art will recognize, these blower control operations can be carried out by a suitably programmed microprocessor which can be configured to independently control the operation of the blower units in the series of blower units.

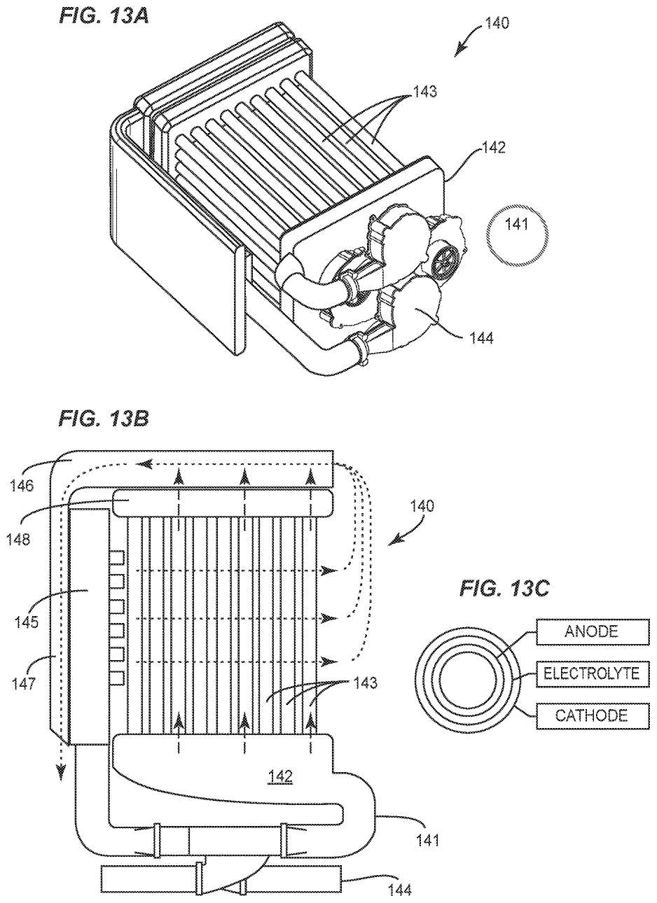

The centrifugal blower system of this invention can manage gas flow requirements for a variety of applications. FIGS. 13A and 13B illustrate the use of the blower system of the invention to provide and mediate gas flows in an SOFC assembly of the tubular type (FIGS. 14A and 14B).

In tubular SOFC assembly, or stack, 140 of FIGS. 13A and 13B, first blower system 141 provides a gaseous fuel, e.g., hydrogen, to manifold 142 for distribution to the interior array 143 of tubular SOFC elements. Each tube in array 143 can be of known or conventional construction and, as shown in FIG. 13C, possesses an innermost fuel-contacting anode layer, intermediate electrolyte layer and outer cathode layer. Second blower system 144 distributes air, initially at ambient temperature, to manifold 145 from which it is released to provide a source of oxygen for the cathode component of each tubular SOFC element. The air entering manifold 145 gains heat from the hot combustion gases exiting tail burner 146 into heat exchanger 147. The dotted lines show the flow path of the heated air existing the outlets of manifold 145, passing through the SOFC array 143 and into tail burner 146 where it provides oxygen to support combustion of unspent fuel present in the exhaust gas emerging from the tubular SOFC elements into exhaust manifold 148 and from there into the tail burner. Finally, the hot combustion gases enter heat exchanger 147 where they serve to preheat incoming air provided by first blower system 141 as previously indicated.

Although the invention has been described in detail for the purpose of illustration, it is understood that such detail is solely for that purpose, and variations can be made therein by those skilled in the art without departing from the spirit and scope of the invention which is defined in the claims.

1. A centrifugal blower system comprising:
a series of blower units, each blower unit in the series comprising a casing having an axial inlet and a radial outlet, an impeller disposed within the casing for drawing a gaseous medium at a first pressure into the axial inlet and expelling gaseous medium at a second higher pressure through the radial outlet and a motor for driving the impeller; and,
a duct connecting the radial outlet of at least one blower unit in the series of blower units with the axial inlet of at least one other blower unit in the series of blower units,
wherein the axial inlet of the at least one blower unit in the series of blower units is positioned substantially opposite to the axial inlet of the at least one other blower unit in the series of blower units.

2. The centrifugal blower system of claim 1 wherein the radial outlets of at least two blower units in the series are substantially opposite to each other.

3. The centrifugal blower system of claim 1 wherein the duct further comprises:
a gas flow-confining wall defining an internal gas flow passageway; and
a gas flow inlet for admitting a gaseous medium to the gas flow passageway of the duct, the gas flow inlet being defined in or connected to the gas flow-confining wall of the duct.

4. The centrifugal blower system of claim 1 wherein the interior walls of the duct are configured to be substantially parallel to the trajectory of the gaseous medium expelled from the radial outlet of a blower unit to which the duct is connected.

5. The centrifugal blower system of claim 1 wherein the outlet of a successive blower unit in the series includes a gas stream housing for receiving the gas stream from the outlet, the walls of the gas stream housing being configured to be substantially parallel to the trajectory of the gaseous medium expelled from the outlet.

6. The centrifugal blower system of claim 1 in which the orientation of the outlet of one blower unit in the series to the inlet of a successive blower unit in the series is approximately 0°, 90°, 180° or 270°.

7. The centrifugal blower system of claim 1 in which the angle of pitch of the outlet of one blower unit in the series to the inlet of a successive blower in the series is 0°, 30°, 60° or 90°.

8. The centrifugal blower system of claim 1 wherein at least one blower unit in the series has greater gas pressure and gas flow capability than another blower unit in the system.

9. The centrifugal blower system of claim 1 wherein the second higher pressure is greater than a second higher pressure generated in a centrifugal blower system which has the axial inlet of at least one blower unit in the series of blower units positioned in the substantially same direction to the axial inlet of at least one other blower unit in the series of blower units.

10. The centrifugal blower system of claim 9 wherein greater second higher pressure is from about 1% greater to about 10% greater than the second higher pressure in the centrifugal blower system which has the axial inlet of at least one blower unit in the series of blower units positioned in the substantially same direction to the axial inlet of at least one other blower unit in the series of blower units.

11. The centrifugal blower system of claim 1 further comprising an air filter over the axial inlet of the at least one blower unit whose radial outlet is connected to the duct, and
wherein the centrifugal blower system has a height which is less than a height of a centrifugal blower system which has the axial inlet of the at least one blower unit in the series of blower units is positioned in substantially same direction to the axial inlet of at least one other blower unit in the series of blower units.

12. The centrifugal blower system of claim 11 wherein the height of the centrifugal blower system is up to 30% less than the height of centrifugal blower system which has the axial inlet of the at least one blower unit in the series of blower units is positioned in substantially same direction to the axial inlet of at least one other blower unit in the series of blower units.

13. The centrifugal blower system of claim 1 further comprising:
an air intake assembly, comprising:
an air intake assembly casing having an air inlet and an air outlet, the air outlet connected to the axial inlet of the blower casing of the at least one blower unit whose radial outlet is connected to the duct; and
a check valve mounted within the air intake assembly casing positioned to permit air flow from the air inlet through to the air outlet and prevent air flow from the air outlet through to the air inlet.

14. The centrifugal blower system of claim 13 wherein the check valve comprises:
a flexible diaphragm attached to the inlet of the air intake assembly casing.

15. The centrifugal blower air intake apparatus of claim 14 wherein the air intake assembly further comprises at least one air filtration unit positioned at at least one of the air inlet and the air outlet.

16. The centrifugal blower system of claim 1 wherein the outlet of the final blower in the series of blower units leads into a flow sensing element which is located downstream at least one other blower unit in the series.

17. The centrifugal blower system of claim 1 further comprising a flow straightener located at the outlet of the final blower in the series and upstream of the flow sensing element.

18. The centrifugal blower system of claim 1 wherein the connection of one blower unit to another blower unit through the duct forms a blower unit pair and wherein the centrifugal blower system comprises at least two blower unit pairs which are mechanically connected to each other and the two blower unit pairs are substantially juxtaposed to each other.

19. The centrifugal blower system of claim 18 wherein the at least two blower unit pairs are substantially juxtaposed to each other in the same plane.

20. The centrifugal blower system of claim 18 wherein one of the blower unit pairs further comprises:
an air intake assembly, comprising:
an air intake assembly casing having an air inlet and an air outlet, the air outlet connected to the axial inlet of the blower casing of the at least one blower unit whose radial outlet is connected to the duct; and
a check valve mounted within the air intake assembly casing positioned to permit air flow from the air inlet through to the air outlet and prevent air flow from the air outlet through to the air inlet.

21-30. (canceled)
